(19) United States
(12) Patent Application Publication
(10) Pub. No.: US 2026/0105124 A1
(43) Pub. Date: Apr. 16, 2026

(54) GENERATING SYNTHETIC DATA USING MACHINE LEARNING MODELS

(71) Applicant: International Business Machines Corporation, Armonk, NY (US)

(72) Inventors: Kelley Anders, East New Market, MD (US); Jeremy R. Fox, Georgetown, TX (US); Andrew Thomas Penrose, Castleknock (IE); Jonathan David Dunne, Dungarvan (IE)

(21) Appl. No.: 18/914,941

(22) Filed: Oct. 14, 2024

(51) Int. Cl. G06F 17/40; G06F 7/02; G06F 17/18

(52) U.S. Cl. CPC G06F 17/40; G06F 7/02; G06F 17/18

(57) ABSTRACT

A computer-implemented method for generating synthetic data. A processor set transforms data in a dataset into a set of new data using a number of transformation techniques identified based on data types for the data. The processor set applies a noise function to the set of new data to generate the synthetic data. The processor set creates a first probability distribution based on the data and a second probability distribution based on the synthetic data. The processor set compares the first probability distribution and the second probability distribution to generate a similarity score. The processor set determines whether the similarity score is within a threshold, where the threshold comprises an upper boundary and a lower boundary. In response to determining that the similarity score is within the threshold, the processor set outputs the synthetic data.

### BACKGROUND

The disclosure relates generally to generating synthetic data.

Synthetic data refers to artificially generated data that mimics real-world data. Synthetic data can be used for a wide range of applications such as machine learning, testing, and simulation. Unlike real data collected from actual events or systems, synthetic data is created using algorithms or models to simulate properties and characteristic of the original data while maintaining privacy and security.

As depicted, synthetic data is widely used in fields such as machine learning model training, testing software systems, and simulating scenarios where collecting real data is impractical or unethical. For example, in autonomous vehicle development, synthetic data helps simulate driving conditions without needing to put cars on the road. In another example, synthetic data can simulate conditions in financial market to test trading algorithms. In yet another example, synthetic data can be used to create patient-like data that preserves privacy but still enables medical research and model development.

### SUMMARY

According to one illustrative embodiment, a computer-implemented method for generating synthetic data is provided. A processor set transforms data in a dataset into a set of new data using a number of transformation techniques identified based on data types for the data. The processor set applies a noise function to the set of new data to generate the synthetic data. The noise function generates noise for the set of new data based on underlying distribution for the set of new data. The processor set creates a first probability distribution based on the data and a second probability distribution based on the synthetic data. The processor set compares the first probability distribution and the second probability distribution to generate a similarity score. The processor set determines whether the similarity score is within a threshold, where the threshold comprises an upper boundary and a lower boundary. In response to determining that the similarity score is within the threshold, the processor set outputs the synthetic data. According to other illustrative embodiments, a computer system and a computer program product for generating synthetic data are provided.

### BRIEF DESCRIPTION OF THE DRAWINGS

FIG. 1 is a pictorial representation of a computing environment in which illustrative embodiments may be implemented;

FIG. 2 is an illustration of a block diagram of a data management environment in accordance with an illustrative embodiment;

FIG. 3A-3B are illustrations of transforming data with different data types in accordance with an illustrative embodiment;

FIG. 4 is a flowchart of a process for generating synthetic data in accordance with an illustrative embodiment;

FIG. 5 is a flowchart of a process for creating probability distribution in accordance with an illustrative embodiment;

FIG. 6 is a flowchart of a process for converting Cartesian coordinates in accordance with an illustrative embodiment; and

FIG. 7 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

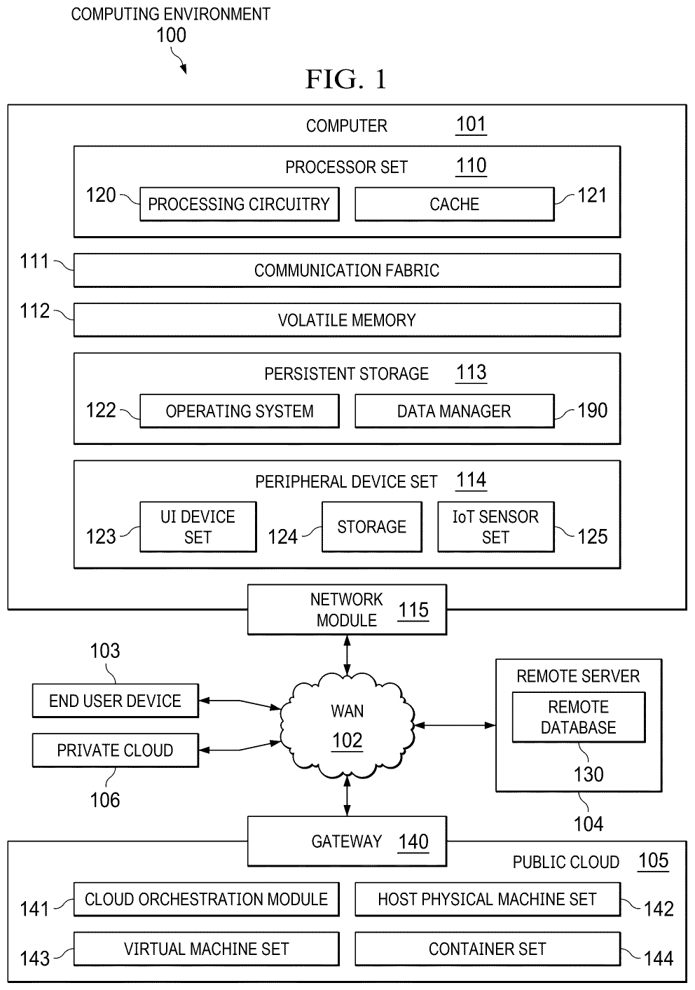

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as data manager 190. In addition to data manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in data manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that real data may not always be available when developing machine learning models, which usually requires large amounts of data for training. The illustrative embodiments also recognize and take into account that using synthetic data can be used as an alternative for training machine learning models since synthetic data can be created in large quantities while protecting sensitive information.

The illustrative embodiments also recognize and take into account that various techniques can be used to generate synthetic data. For example, synthetic data can be generated using statistical models, machine learning model algorithms, and generative adversarial networks (GANs).

The illustrative embodiments also recognize and take into account that it is optimal to have synthetic data not too similar to the real world data and not too distinct from the real world data such that the synthetic data remain valid for downstream analysis while maintaining a sufficient separation.

Thus, illustrative embodiments of the present invention provide a computer implemented method, computer system, and computer program product for generating synthetic data. In one illustrative example, a computer implemented method generates synthetic data. A processor set transforms data in a dataset into a set of new data using a number of transformation techniques identified based on data types for the data. The processor set applies a noise function to the set of new data to generate the synthetic data. The noise function generates noise for the set of new data based on underlying distribution for the set of new data. The processor set creates a first probability distribution based on the data and a second probability distribution based on the synthetic data. The processor set compares the first probability distribution and the second probability distribution to generate a similarity score. The processor set determines whether the similarity score is within a threshold, wherein the threshold comprises an upper boundary and a lower boundary. In response to determining that the similarity score is within the threshold, the processor set outputs the synthetic data.

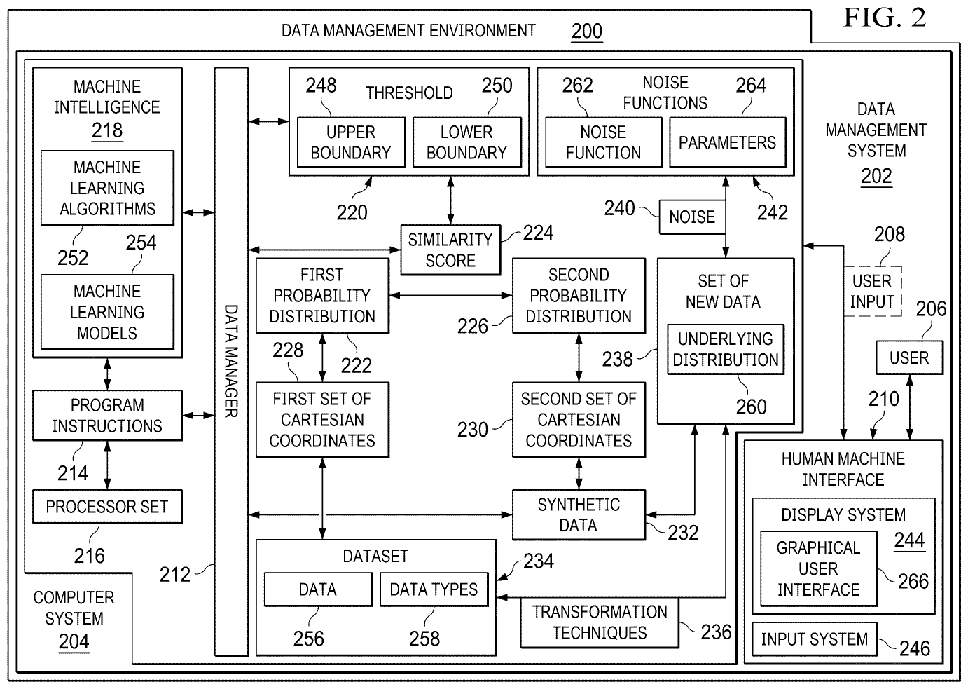

With reference now to FIG. 2, an illustration of a block diagram of a data management environment is depicted in accordance with an illustrative embodiment. In this illustrative example, data management environment 200 includes components that can be implemented in hardware such as the hardware shown in computing environment 100 in FIG. 1.

In this illustrative example, data management system 202 in data management environment 200 uses data manager 212 to generate synthetic data 232. In this illustrative example, data management system 202 includes computer system 204 which includes data manager 212. Data manager 212 is located in computer system 204. Data manager 212 may be implemented using data manager 190 in FIG. 1.

Data manager 212 can be implemented in software, hardware, firmware, or a combination thereof. When software is used, the operations performed by data manager 212 can be implemented in program instructions configured to run on hardware, such as a processor unit. When firmware is used, the operations performed by data manager 212 can be implemented in program instructions and data and stored in persistent memory to run on a processor unit. When hardware is employed, the hardware can include circuits that operate to perform the operations in data manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations”is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, computer system 204 includes dataset 234. In this illustrative example, dataset 234 includes data 256 that serves as the original data for generating synthetic data 232. In this illustrative example, data manager 212 can apply transformation techniques 236 to data 256 based on data types 258 for data 256 to generate set of new data 238. Data types 258 can include text, image, audio, video, or any suitable data types. In other words, data 256 can be textual data, image data, audio data, video data, or any suitable type of data.

In this illustrative example, transformation techniques 236 can include a number of data transformation techniques. For example, data manager 212 can use a large language model to transform textual data from data 256. In this example, the large language model used for data transformation can be a part of machine intelligence 218. In another example, data manager 212 can use BoxCox transformations to transform geospatial data from data 256. In another illustrative example, data manager 212 can use Tukey's ladder of power transformations to transform data with discrete data type or continuous data type.

In this illustrative example, transformation techniques 236 slightly changes the content of data 256 to generate set of new data 238. However, the contextual information and semantic information is unchanged between data 256 and set of new data 238. In this illustrative example, data manager 212 can also uses transformation techniques 236 to convert non-numerical data in data 256 and set of new data 238 into vector embeddings such that data in data 256 and set of new data 238 becomes numerical data for further processing. In this illustrative example, transformation techniques 236 are used to change the scale of numerical data. In addition, transformation techniques 236 can also be used to reduce or increase dispersion of dataset 234 depending on strength of transformation applied.

As depicted, computer system 204 includes machine intelligence 218. Machine intelligence 218 can include machine learning models 254 and machine learning algorithms 252. Machine learning models 254 is a branch of artificial intelligence (AI) that enables computers to detect patterns and improve performance without direct programming commands. Rather than relying on direct input commands to complete a task, machine learning models 254 relies on input data. The data is fed into the machine, one of machine learning algorithms 252 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. Machine learning model 254 and machine learning algorithms 252 may make computer system 204 a special purpose computer for transforming data 256 and generate synthetic data 232.

Machine learning model 254 involves using machine learning algorithms 252 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 252 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

In this illustrative example, machine learning models 254 can be retrained or updated using new data or outputs generated by machine learning models 254 such that parameters in machine learning algorithm selected for machine learning models 254 can be adjusted to improve accuracy and efficiency of machine learning models 254.

Data manager 212 applies a noise function such as noise function 262 from noise functions 242 to set of new data 238 to generate synthetic data 232. Noise functions 242 such as noise function 262 are mathematical functions that generate noise random or pseudo-random values that can be used to simulate randomness or natural variability in data. For example, noise functions 242 can generate noise 240 to set of new data 238 based on underlying distribution 260 for set of new data 238. Underlying distribution 260 is the statistical distribution that best describes probability structure or pattern for data in set of new data 238. In an alternative illustrative example, data manager 212 can also use a probability distribution to allow noise 240 that is applied to set of new data 238 to mimic the shape of data for set of new data 238. For example, the probability distribution can be a Weibull distribution, a Pareto distribution, a log-logistic distribution, or any suitable probability distribution and probability density distribution.

In this illustrative example, noise functions 242 can include jitter functions, Gaussian noise function, Perlin noise function, uniform noise function, impulse noise function, quantisation noise function, or any suitable noise function.

As depicted, synthetic data 232 is generated by applying a noise function such as noise function 262 from noise functions 242. In this illustrative example, data manager 212 can convert data 256 from dataset 234 into first set of Cartesian coordinates 228 and synthetic data 232 into second set of Cartesian coordinates 230. Cartesian coordinates refer to points in a coordinate system that uses two or more perpendicular axes to represent points in space. In this illustrative example, each data point in data 256 and synthetic data 232 is represented by coordinates in first set of Cartesian coordinates 228 and second set of Cartesian coordinates 230.

In this illustrative example, data manager 212 uses first set of Cartesian coordinates 228 to generate first probability distribution 222. In this illustrative example, data points that are represented by coordinates in first set of Cartesian coordinates 228 are transformed to follow a specific probability distribution such as first probability distribution 222. In this illustrative example, first probability distribution 222 can be a Gaussian distribution, a Weibull distribution, a Pareto distribution, a log-logistic distribution, or any suitable probability density distribution and probability density distribution.

In a similar fashion, data manager 212 uses second set of Cartesian coordinates 230 to generate second probability distribution 226. In this illustrative example, data points that are represented by coordinates in second set of Cartesian coordinates 230 are transformed to follow a specific probability distribution such as second probability distribution 226. In this illustrative example, first probability distribution 222 and second probability distribution 226 can be Gaussian distributions, Weibull distributions, Pareto distributions, log-logistic distributions, or any suitable probability distributions and probability density distributions. In this illustrative example, first probability distribution 222 second probability distribution 226 can be Gaussian distribution pairs in two dimensional spaces.

Data manager 212 compares first probability distribution 222 and second probability distribution 226 to generate similarity score 224. In this illustrative example, data manager 212 can compare first probability distribution 222 and second probability distribution 226 in a number of ways. For example, data manager 212 can use a Kullback Leibler (KL) divergence test to compare first probability distribution 222 and second probability distribution 226. In this example, the KL divergence test compares the divergence between the two distributions and generates a score to indicate similarities between two distributions. For example, a lower score from the KL divergence test indicates more similar distributions such that an inference of whether synthetic data 232 is similar to data 256 from dataset 234 while preserving a degree of anonymity.

In this illustrative example, data manager 212 uses threshold 220 to determine whether synthetic data 232 can be output. As depicted, the purpose of using the method mentioned above is to generate synthetic data such as synthetic data 232 that is similar to original data such as data 256 while preserving a degree of anonymity. In other words, synthetic data 232 will be outputted when first probability distribution 222 for synthetic data 232 is neither too similar nor too distinct to second probability distribution 226 for data 256.

In this illustrative example, threshold 220 can include upper boundary 248 and lower boundary 250 to define a range for threshold 220 such that a value of similarity score 224 that falls in between upper boundary 248 and lower boundary 250 indicates that synthetic data 232 is similar to data 256 from dataset 234 while preserving a degree of anonymity. However, if similarity score 224 is not within upper boundary 248 and lower boundary 250 for threshold 220, data manager 212 regenerates data for synthetic data 232 by applying a different noise function in noise functions 242 to set of new data 238. In an alternative illustrative example, data manager 212 can also adjust parameters 264 for noise function 262 such that noise 240 applied to set of new data 238 is different compared to previous noise, therefore generating different data for synthetic data 232. In this illustrative example, data manager 212 repeats the process described above until similarity score 224 is within the range defined by upper boundary 248 and lower boundary 250 for threshold 220. In other words, data manager 212 outputs synthetic data 232 when similarity score 224 is within the range defined by upper boundary 248 and lower boundary 250 for threshold 220. In this illustrative example, threshold 220 can be user-defined or automatically defined using machine intelligence 218.

In this illustrative example, synthetic data 232 that is output by data manager 212 can be further used in a number of applications. For example, synthetic data 232 can be used for scientific simulation in medical research, fraud detection and risk management in financial industry, or training machine learning models such as machine learning models 254 in machine intelligence 218 for field such as robotics, autonomous driving, natural language processing, or supply chain and logistics planning. In an alternative example, synthetic data 232 can also be output data manager 212 to resolve issues caused by small datasets. For example, small datasets usually provide poor downstream performance. In this case, it is preferable to generate additional observations that are representative of original data from those small datasets.

In this illustrative example, user 206 can interact with computer system 204 through user inputs to computer system 204. For example, computer system 204 can receive user input 208 that defines upper boundary 248 and lower boundary 250 for threshold 220.

In this illustrative example, user input 208 can be generated by user 206 using human machine interface (HMI) 210. As depicted, human machine interface 210 includes display system 244 and input system 246. Display system 244 is a physical hardware system and includes one or more display devices on which graphical user interface 266 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 266 through user input 208 generated by input system 246. Input system 246 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device.

In one illustrative example, one or more solutions are present that overcome a problem with generating synthetic data. As a result, one or more technical solutions may provide an ability to increase the efficiency for utilizing memory in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which data manager 212 in computer system 204 enables generation of synthetic data such as synthetic data 232. In particular, data manager 212 transforms computer system 204 into a special purpose computer system as compared to currently available general computer systems that do not have a data manager 212.

The illustration of data management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, first set of Cartesian coordinates 228 and second set of Cartesian coordinates 230 can be converted to polar coordinates such that generation of first probability distribution 222 and second probability distribution 226 can be more efficient and simplified.

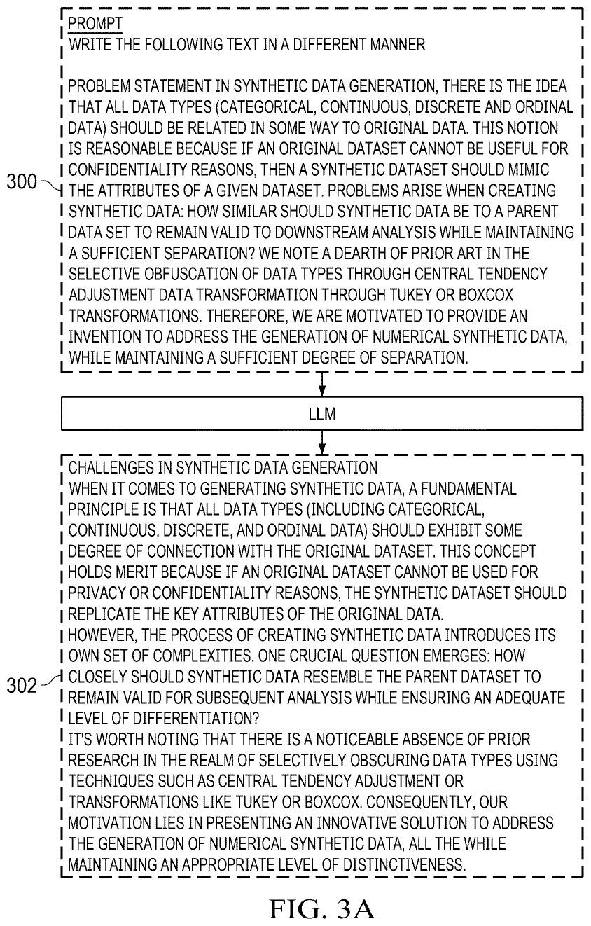

With reference now to FIG. 3A-3B, illustrations of transforming data with different data types are shown in accordance with an illustrative embodiment. In FIG. 3A, data 300 includes textual data that is used as a prompt to a large language model. In this illustrative example, data 300 can be transformed into data 302 using the large language model such that data 302 can serve as a meaningful alternative textual data for data 300. Subsequently, a noise function can be applied to data 302 for generating synthetic data using the method described above in FIG. 2. In this example, transformation through large language model can be an example of transformation techniques 236 in FIG. 2, data 300 can be an example of data 256 in dataset 234 in FIG. 2, and data 302 can be an example of set of new data 238 in FIG. 2.

In a similar fashion, data 304 in FIG. 3B includes geospatial data that can be transformed using BoxCox transformation. BoxCox transformation is a statistical technique used to stabilize variance and make data more normally distributed. BoxCox transformation is often applied in situations where data exhibits skewness or unequal variance. In this illustrative example, data 304 can be transformed into data 306 using BoxCox transformation such that data 306 can serve as a meaningful alternative geospatial data for data 304. In this example, BoxCox transformation can be an example of transformation techniques 236 in FIG. 2, data 304 can be an example of data 256 in dataset 234 in FIG. 2, and data 306 can be an example of set of new data 238 in FIG. 2. In this illustrative example, the coordinate points in data 304 and data 306 may be changed by the BoxCox transformation. However, the synthetic data is generated based on data 306 in such a way that the distances between points are consistent with Euclidian distance or elliptical distance.

The illustration of data transformation shown in FIG. 3A-3B is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, other transformation techniques other than using large language model or BoxCox transformation can be used to transform data 300 and data 304. In addition, the transformation techniques for data can be selected based on data type of the data.

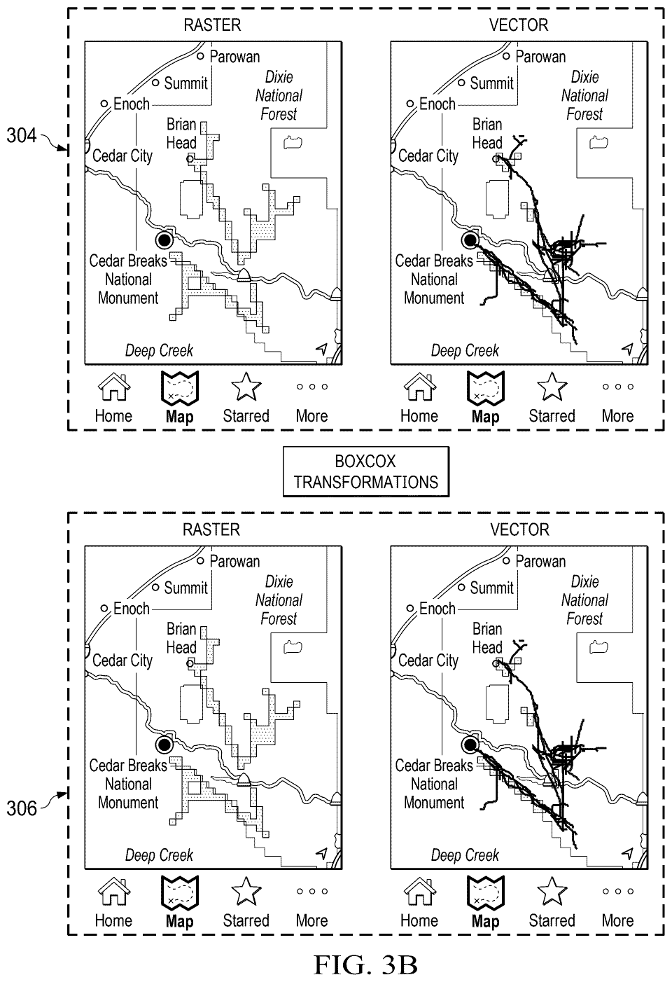

With reference now to FIG. 4, a flowchart illustrating a process for generating synthetic data is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in data manager 212 in computer system 204 in FIG. 2.

The process begins by transforming data in a dataset into a set of new data using a number of transformation techniques identified based on data types for the data (step 400). The process applies a noise function to the set of new data to generate synthetic data (step 402). In step 402, the noise function generates noise for the set of new data based on underlying distribution for the set of new data.

The process creates a first probability distribution based on the data and a second probability distribution based on the synthetic data (step 404). The process compares the first probability distribution and the second probability distribution to generate a similarity score (step 406). The process determines whether the similarity score is within a threshold (step 408). In this step, the threshold is a range that has an upper boundary and a lower boundary.

If the similarity is not within the threshold, the process returns to step 402 and repeats step 402 to step 408 until the similarity score is within the threshold. In this illustrative example, the process can either adjust parameters in the noise function or applies a new noise function to the set of new data for generating the synthetic data every time step 402 is repeated. With reference again to step 408, if the similarity score is within the threshold, the process proceeds to step 410 to output the synthetic data (step 410). The process terminates thereafter.

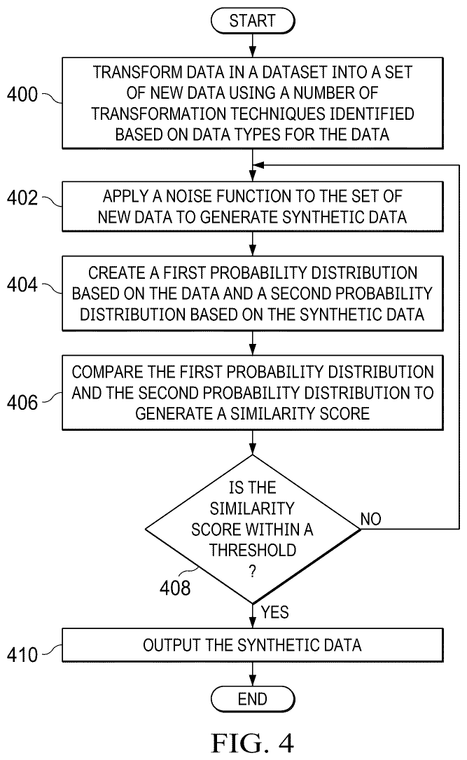

Turning next to FIG. 5, a flowchart of a process for creating probability distribution is depicted in accordance with an illustrative embodiment. The process in this flowchart is an example of an implementation for step 404 in FIG. 4.

The process begins by converting the data into a first set of Cartesian coordinates and the synthetic data into a second set of Cartesian coordinates (step 500). The process creates the first probability distribution based on the first set of Cartesian coordinates, and the second probability distribution based on the second set of Cartesian coordinates (step 502). The process terminates thereafter.

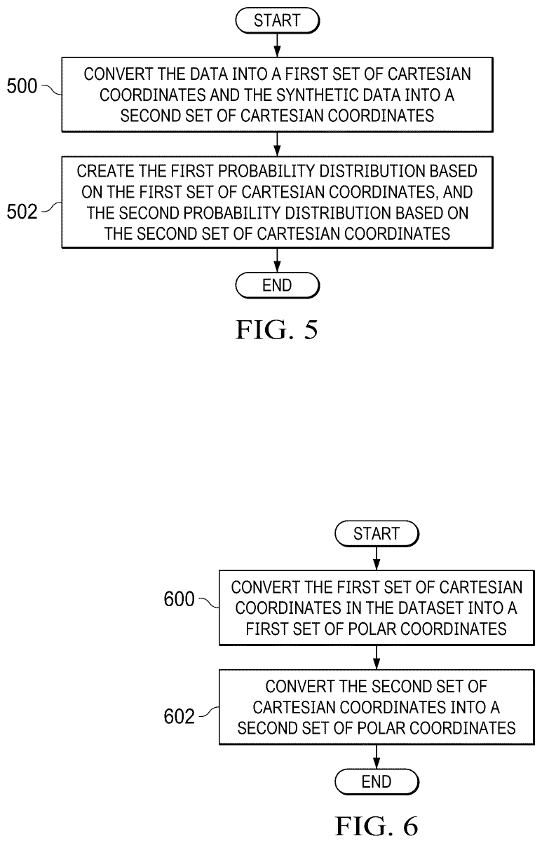

Turning next to FIG. 6, a flowchart of a process for converting cartesian coordinates is depicted in accordance with an illustrative embodiment. The process in this figure is an example of an additional step that can be performed with the steps in FIG. 5.

The process begins by converting the first set of Cartesian coordinates in the dataset into a first set of polar coordinates (step 600). The process converts the second set of Cartesian coordinates into a second set of polar coordinates (step 602). The process terminates thereafter.

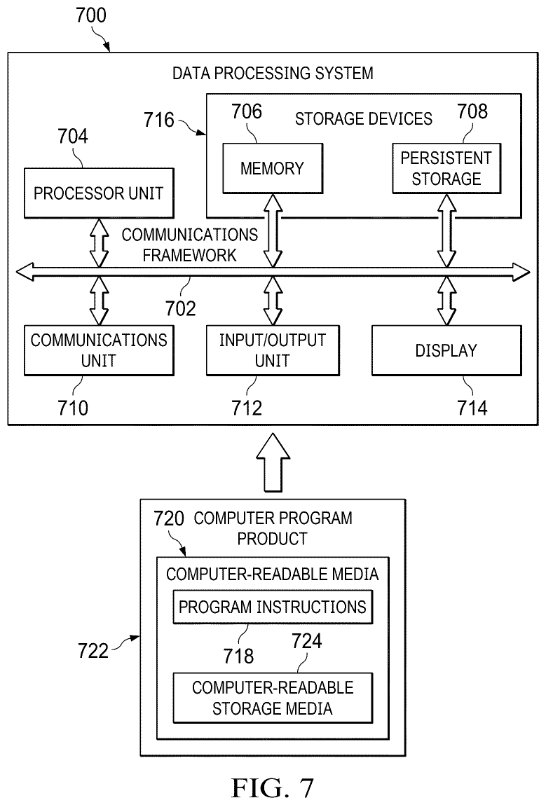

Turning now to FIG. 7, a block diagram of a data processing system is depicted in accordance with an illustrative embodiment. Data processing system 700 can be used to implement computers and computing devices in computing environment 100 in FIG. 1. Data processing system 700 can also be used to implement computer system 204 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 704 can be implemented using one or more heterogeneous processor systems in which a main processor is present with secondary processors on a single chip. As another illustrative example, processor unit 704 can be a symmetric multi-processor system containing multiple processors of the same type on a single chip.

Memory 706 and persistent storage 708 are examples of storage devices 716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 may take various forms, depending on the particular implementation.

For example, persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which may be located in a memory, such as memory 706.

These instructions are referred to as program instructions, computer usable program instructions, or computer-readable program instructions that can be read and executed by a processor in processor unit 704. The program instructions in the different embodiments can be embodied on different physical or computer-readable storage media, such as memory 706 or persistent storage 708.

Program instructions 718 are located in a functional form on computer-readable media 720 that is selectively removable and can be loaded onto or transferred to data processing system 700 for execution by processor unit 704. Program instructions 718 and computer-readable media 720 form computer program product 722 in these illustrative examples. In the illustrative example, computer-readable media 720 is computer-readable storage media 724.

Computer-readable storage media 724 is a physical or tangible storage device used to store program instructions 718 rather than a medium that propagates or transmits program instructions 718. Computer-readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 718 can be transferred to data processing system 700 using a computer-readable signal media. The computer-readable signal media are signals and can be, for example, a propagated data signal containing program instructions 718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program instructions 718 can be located in computer-readable media 720 in the form of a single storage device or system. In another example, program instructions 718 can be located in computer-readable media 720 that is distributed in multiple data processing systems. In other words, some instructions in program instructions 718 can be located in one data processing system while other instructions in program instructions 718 can be located in one data processing system. For example, a portion of program instructions 718 can be located in computer-readable media 720 in a server computer while another portion of program instructions 718 can be located in computer-readable media 720 located in a set of client computers.

The different components illustrated for data processing system 700 are not meant to provide architectural limitations to the manner in which different embodiments can be implemented. In some illustrative examples, one or more of the components may be incorporated in or otherwise form a portion of another component. For example, memory 706, or portions thereof, may be incorporated in processor unit 704 in some illustrative examples. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program instructions 718.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for generating synthetic data, the computer implemented method comprising:
transforming, by a processor set, data in a dataset into a set of new data using a number of transformation techniques identified based on data types for the data;
applying, by the processor set, a noise function to the set of new data to generate the synthetic data, wherein the noise function generates noise for the set of new data based on underlying distribution for the set of new data;
creating, by the processor set, a first probability distribution based on the data and a second probability distribution based on the synthetic data;
comparing, by the processor set, the first probability distribution and the second probability distribution to generate a similarity score;
determining, by the processor set, whether the similarity score is within a threshold, wherein the threshold comprises an upper boundary and a lower boundary; and
in response to determining that the similarity score is within the threshold, outputting, by the processor set, the synthetic data.

2. The computer implemented method of claim 1, further comprising:
in response to determining that the similarity score is not within the threshold, adjusting, by the processor set, parameters in the noise function; and
repeating, by the processor set, the applying step, creating step, comparing step, and determining step until the similarity score is within the threshold.

3. The computer implemented method of claim 1, wherein the creating, by the processor set, the first probability distribution based on the data and the second probability distribution based on the synthetic data comprises:
converting, by the processor set, the data into a first set of cartesian coordinates and the synthetic data into a second set of cartesian coordinates; and
creating, by the processor set, the first probability distribution based on the first set of cartesian coordinates, and the second probability distribution based on the second set of cartesian coordinates.

4. The computer implemented method of claim 3, further comprising:
converting, by the processor set, the first set of cartesian coordinates into a first set of polar coordinates; and
converting, by the processor set, the second set of cartesian coordinates into a second set of polar coordinates.

5. The computer implemented method of claim 1, wherein the noise function comprises a jitter function.

6. The computer implemented method of claim 1, wherein the first probability distribution and the second probability distribution comprise at least one of Gaussian distribution, Weibull distribution, Pareto distribution, and log-logistic distribution.

7. The computer implemented method of claim 6, wherein the first probability distribution and the second probability distributions are Gaussian distribution pairs in two dimensional spaces.

8. A computer system comprising:
a processor set;
a set of one or more computer-readable storage media; and
program instructions stored on the set of one or more storage media to cause the processor set to perform operations comprising:
transforming data in a dataset into a set of new data using a number of transformation techniques identified based on data types for the data;
applying a noise function to the set of new data to generate synthetic data, wherein the noise function generates noise for the set of new data based on underlying distribution for the set of new data;
creating a first probability distribution based on the data and a second probability distribution based on the synthetic data;
comparing the first probability distribution and the second probability distribution to generate a similarity score;
determining whether the similarity score is within a threshold, wherein the threshold comprises an upper boundary and a lower boundary; and
in response to determining that the similarity score is within the threshold, outputting, by the processor set, the synthetic data.

9. The computer system of claim 8, wherein the operations further comprise:
in response to in response to determining that the similarity score is not within the threshold, adjusting, by the processor set, parameters in the noise function; and
repeating the applying step, creating step, comparing step, and determining step until the similarity score is within the threshold.

10. The computer system of claim 8, wherein the creating the first probability distribution based on the data and the second probability distribution based on the synthetic data comprises:
converting the data into a first set of cartesian coordinates and the synthetic data into a second set of cartesian coordinates; and
creating the first probability distribution based on the first set of cartesian coordinates, and the second probability distribution based on the second set of cartesian coordinates.

11. The computer system of claim 10, wherein the operations further comprise:
converting the first set of cartesian coordinates in the dataset into a first set of polar coordinates; and
converting the second set of cartesian coordinates into a second set of polar coordinates.

12. The computer system of claim 8, wherein the noise function comprises a jitter function.

13. The computer system of claim 8, wherein the first probability distribution and the second probability distribution comprise at least one of Gaussian distribution, Weibull distribution, Pareto distribution, and log-logistic distribution.

14. The computer system of claim 13, wherein the first probability distribution and the second probability distributions are Gaussian distribution pairs in two dimensional spaces.

15. A computer program product for generating synthetic data, the computer program product comprising:
a set of one or more computer-readable storage media;
program instructions stored in the set of one or more storage media to perform operations comprising:
transforming, by a processor set, data in a dataset into a set of new data using a number of transformation techniques identified based on data types for the data;
applying, by the processor set, a noise function to the set of new data to generate the synthetic data, wherein the noise function generates noise for the set of new data based on underlying distribution for the set of new data;
creating, by the processor set, a first probability distribution based on the data and a second probability distribution based on the synthetic data;
comparing, by the processor set, the first probability distribution and the second probability distribution to generate a similarity score;
determining, by the processor set, whether the similarity score is within a threshold, wherein the threshold comprises an upper boundary and a lower boundary; and
in response to determining that the similarity score is within the threshold, outputting, by the processor set, the synthetic data.

16. The computer program product of claim 15, wherein the operations further comprise:
in response to in response to determining that the similarity score is not within the threshold, adjusting, by the processor set, parameters in the noise function; and
repeating, by the processor set, the applying step, creating step, comparing step, determining step until the similarity score is within the threshold.

17. The computer program product of claim 15, wherein the creating, by the processor set, the first probability distribution based on the data and the second probability distribution based on the synthetic data comprises:
converting, by the processor set, the data into a first set of cartesian coordinates and the synthetic data into a second set of cartesian coordinates; and
creating, by the processor set, the first probability distribution based on the first set of cartesian coordinates, and the second probability distribution based on the second set of cartesian coordinates.

18. The computer program product of claim 17, wherein the operations further comprise:
converting, by the processor set, the first set of cartesian coordinates in the dataset into a first set of polar coordinates; and
converting, by the processor set, the second set of cartesian coordinates into a second set of polar coordinates.

19. The computer program product of claim 15, wherein the noise function comprises a jitter function.

20. The computer program product of claim 15, wherein the first probability distribution and the second probability distribution comprise at least one of Gaussian distribution, Weibull distribution, Pareto distribution, and log-logistic distribution.
